(19) United States
(12) Patent Application Publication
(10) Pub. No.: US 2025/0113792 A1
(43) Pub. Date: Apr. 10, 2025

(54) SYSTEM AND A METHOD FOR HYDROPONIC CULTURE

(71) Applicant: GARANT GP, Saint-François-de-la-Rivière-du-Sud (CA)

(72) Inventors: Carl BLOUIN, Lévis (CA); David BOIES, Lévis (CA)

(21) Appl. No.: 18/910,718

(22) Filed: Oct. 9, 2024

Related U.S. Application Data
(60) Provisional application No. 63/589,054, filed on Oct. 10, 2023.

(51) Int. Cl. A01G 31/02

(52) U.S. Cl. CPC A01G 31/02

(57) ABSTRACT

A hydroponic culture pod comprising a germination tray comprising flexible elements configured to support plant seeds and suspended between inner walls of the pod, while anchoring cones extending from the inner walls of the pod support and anchor plants growing from the seeds and expanding out a top of the pod. The pod may be placed in a grow tray fed with a nutrient solution from a reservoir in a hydroponic culture system. The pod allows hydroponic growing.

### FIELD OF THE INVENTION

This application claims benefit, under 35 U.S.C. § 119 (e), of U.S. provisional application Ser. No. 63/589,054, filed on Oct. 10, 2023. All documents above are incorporated herein in their entirety by reference.

The present invention relates to hydroponic culture. More specifically, the present invention is concerned with a system and a method for hydroponic culture.

### BACKGROUND OF THE INVENTION

Hydroponic growing systems typically use growth baskets filled with growth substrates selected for supporting growing roots, such as rockwool, perlite, vermiculite, or coco coir, which are disposed of after each cycle of growth; or reusable clay balls, which may be reused providing rinsing, soaking and PH neutralization between cycles, for example. In intensive horticultural production, reusable baskets are used for initiating germination in a minimized space, before transfer, once seedings are obtained, to a growing system dedicated to the growth of the plants. This transplanting step may damage the fragile root system; and may also be a deterrent for people in residential horticultural production. However, baskets allowing both seeding and growing are generally difficult to reuse, since removal of the plant and of the growth substrates proves difficult.

There is still a need in the art for a system and a method for hydroponic culture.

### BRIEF DESCRIPTION OF THE DRAWINGS

In the Appended Drawings:

FIG. 1 is a perspective view of a pod according to an embodiment of an aspect of the present disclosure;

FIG. 2 is a perspective exploded view of the pod of FIG. 1;

FIG. 3 is a cross section along line A_A of the pod of FIG. 1;

FIG. 4A is a perspective view of the left side of the pod of FIG. 1, with the left end of a germination tray on the insert of the left side;

FIG. 4B is a perspective view of the right side of the pod of FIG. 1;

FIG. 5 is a top perspective view of a germination tray according to an embodiment of an aspect of the present disclosure;

FIG. 6A is a schematical view of a system according to an embodiment of an aspect of the present disclosure, with pump on; and

FIG. 6B is a schematical view of the system of FIG. 6A, with pump off, according to an embodiment of an aspect of the present disclosure.

### DESCRIPTION OF ILLUSTRATIVE EMBODIMENTS

The present invention is illustrated in further details by the following non-limiting examples.

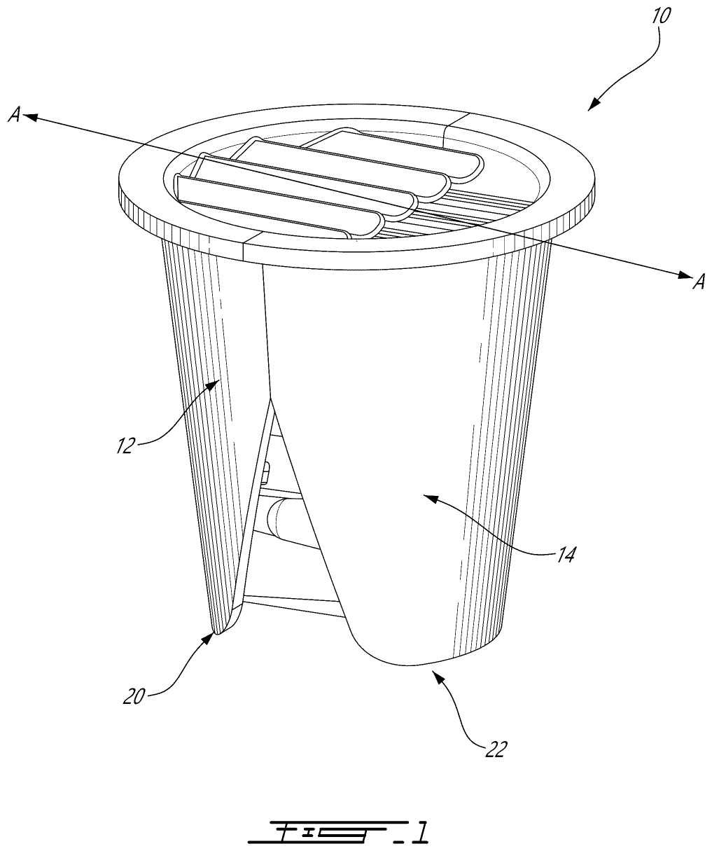

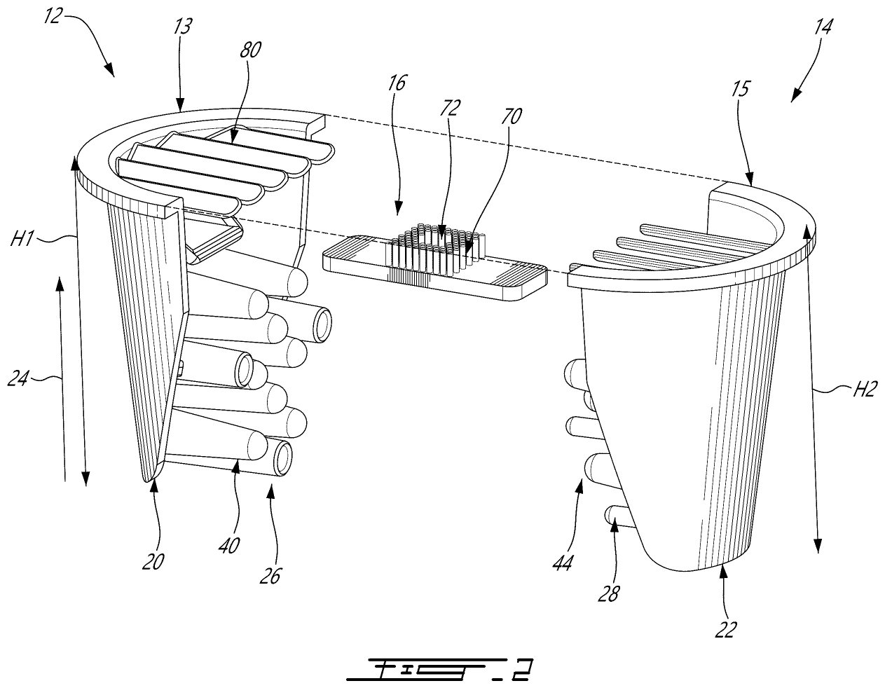

A pod 10 according to an embodiment of an aspect of the present disclosure, as illustrated in FIGS. 1-4, comprises a first part 12, a second part 14 and a germination tray 16, best seen in the exploded view of FIG. 2.

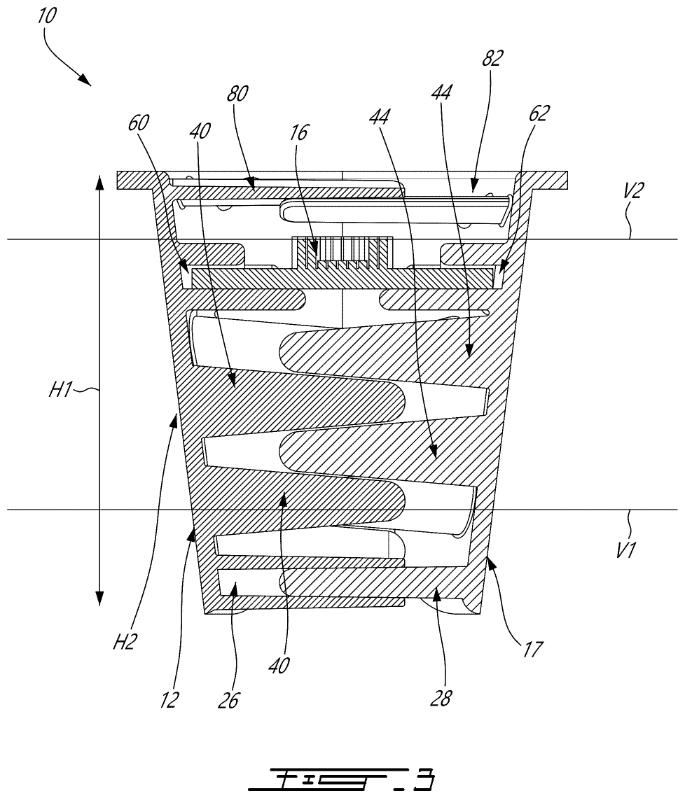

The germination tray 16 may be seen in FIGS. 2-5 as a plate, suspended within the pod (FIG. 3), with bristles 70 on an upper surface thereof.

The first part 12 of the pod 10 comprises, along a height H1 of a side wall 11 thereof between a bottom wall 20 thereof and a top edge 13 thereof, and extending from the inner surface of the side wall 11: anchoring cones 40 and an insert 60;T the second part 14 of the pod 10, comprises, along a height H2 of a side wall 17 thereof and extending from the inner surface of the side wall 17, between a bottom wall 22 thereof and a top edge 15 thereof anchoring cones 44 and an insert 62.

The inserts 60, 62 may be shelves or sleeves on the inner facing surfaces of the side walls 11, 17 of the first and the second parts 12, 14, used to support the germination tray 16 within the pod in the closed position of the pod.As best seen in FIG. 3, in the closed position of the pod, the germination tray 16 is supported within the pod with the bristles 70 available to support seeds; the water level may be monitored, for example between a minimum water level V1 and a maximum water level V2, during irrigation cycles as will be discussed hereinbelow. The germination tray may comprise a recessed surface as a small reservoir of solution in contact with the seed between irrigation cycles.

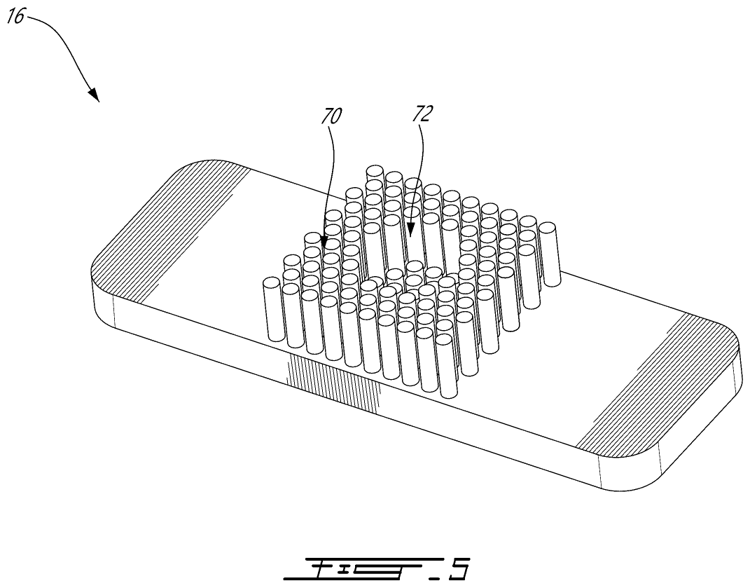

The bristles 70 are selected as flexible elements that allow the water to reach the seeds, while keeping the seeds in place on the germination tray 16. The bristles length and/or diameter and/or shape and/or density may be selected on the same germination so that shorter bristles are used, for example in an area 72 in the center of the array as illustrated in FIGS. 2 and 5, to secure larger sized seeds, while smaller size seeds are hold in place using longer bristles, for example. The anchoring cones 40, 44 extend, in staggered relationship for example, from the inner surfaces of the side walls 11 and 14 of the pod, to support and anchor the plant as it grows and expands, in absence of growing media such as rockwool, perlite, vermiculite, coco coir. Thus, seeds may germinate directly in the pod in which the resulting plant may live and thrive for its complete lifetime.

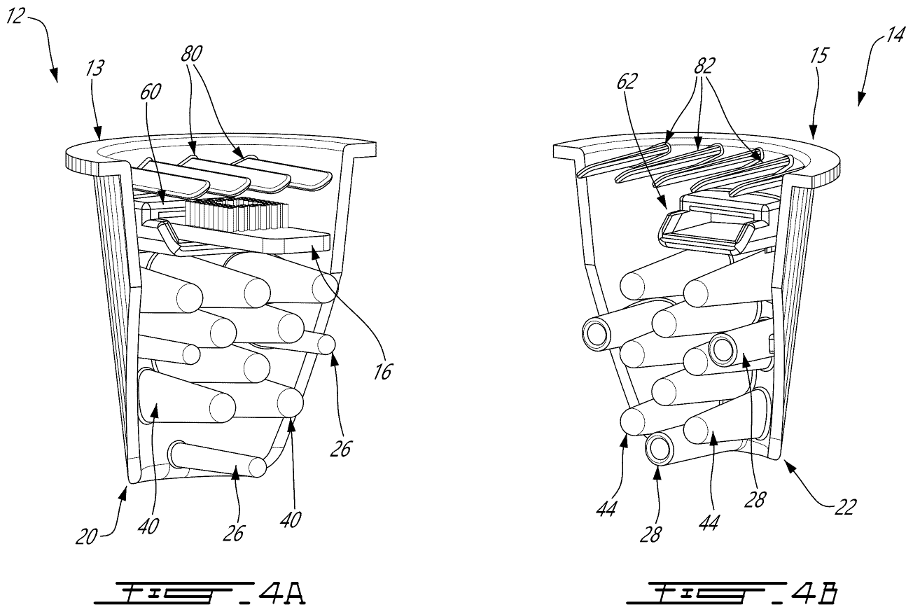

The first part 12 may further comprises aligning female pins 26 and/or shading blinds 80 (FIGS. 3 and 4) extending from the inner surface of the side wall 11; the second part 14 may further comprises aligning male pins 28 and/or shading blinds 82. As exemplified in FIG. 2, the aligning female/male pins 26, 28 are positioned along the height of the first and second parts for mating engagement in the closed position of the pod shown in FIGS. 1, 3. Other male-female locking combination may be used, such as Velcro or peripheral strap, for example.

The shading blinds 80, 82 are flexible elements, such as bristles or thin wings as illustrated herein for example, selected to provide protection of the seeds from light to promote germination, while allowing emerging shoots to go through and to the open top of the pod.

The anchoring cones, the germination tray, the locking elements and shading blinds may be made in a soft flexible material such as an elastomer, for example a food grade silicone. The pod may be cleaned in a dishwasher for example, and sterilized between uses, and reusable.

The pod may be used in a hydroponic system for the entire life of the plant, from seed germination to full growth of the plant.

Transparent domes may be secured over the pod during the early stages of germination to maintain the humidity level. Lights, such as light emitting diodes (LED) for example, may be secured on top of the pod for heating.

A hydroponic growing method according to an embodiment of an aspect of the present disclosure comprises placing seeds in an array of bristles on a germination tray (FIG. 5), inserting the germination tray into one of the two parts of the pod (see FIG. 4 for example), and closing the pod by engaging the first and second parts together in a mating position in the closed position of the pod as illustrated in FIGS. 1 and 3 for example.

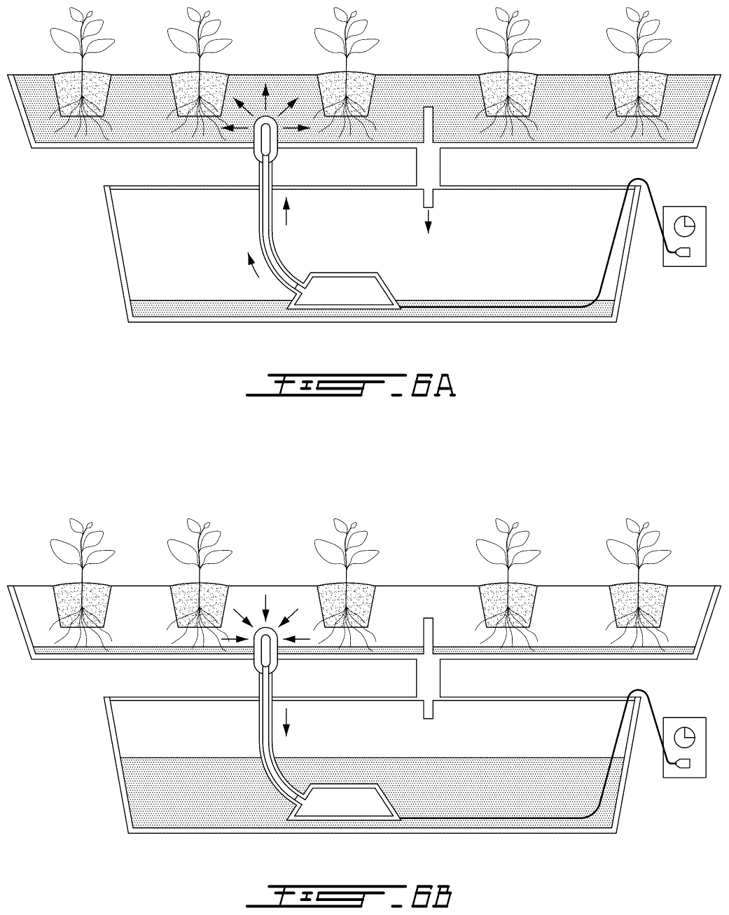

The presently disclosed pod may be used in a tidal system growth system as schematically illustrated in FIG. 6 for example, with a reservoir R of nutrient solution pumped to a grow tray G. Pods placed in a grow tray G are soaked in a nutrient solution pumped from reservoir R according to a circulation program selectively activating the nutrient solution pumping from the reservoir R to the grow tray G depending on target seeds and plants. In an ebb and flow pattern, when the pump runs (FIG. 6A), the solution is pumped from the reservoir to a predetermined maximum level in the grow tray, excess solution returning to the reservoir; when the pump stops, the solution flows back to the reservoir until it reaches a predetermined minimum level in the grow tray (FIG. 6B). Thus, during the germination phase, the solution level is selectively controlled to periodically reach the seeds in the pods in the grow tray so as to keep them moist; over time, the seeds germinate and start forming roots that grow toward the bottom of the pods to reach the nutrient solution in the grow tray, and stems grow upward and make their way between the shading blinds of the pods to reach light at the open top of the pods. The plants may continue to grow in the pods for their entire life. As the plants grow, the roots develop and are exposed to air along the height of the pods between the irrigation cycles, which correspond to the tidal cycles, providing oxygen to the plants and promoting further roots to grow.

The presently disclosed pod may also be used by placing the pod in a reservoir of nutrient solution in a position allowing the nutrient solution to reach the seeds in the germination tray during the germination stage and reducing the nutrient solution level as the roots and plant grow. The solution may also be provided onto the germination tray from the top of the pod and the supply of nutrient solution monitored with alternating on/off pumping programming, or dripping into the germination tray and flowing down back to the grow tray.

The scope of the claims should not be limited by the embodiments set forth in the examples, but should be given the broadest interpretation consistent with the description as a whole.

The invention claimed is:

1. A hydroponic culture pod, comprising:
a germination tray suspended between inner walls of the pod; and
anchoring cones extending from the inner walls of the pod;
wherein the germination tray comprises flexible elements configured to support plant seeds, and said anchoring cones support and anchor plants growing from the seeds and expanding out a top of the pod.

2. The hydroponic culture pod of claim 1, further comprising shading blinds extending from the inner walls of the pod between the germination tray and the top of the pod; wherein said shading blinds are flexible elements selected to provide protection from light while allowing shoots from the seeds to go through and emerge at the top of the pod.

3. The hydroponic culture pod of claim 1, comprising a first part and a second part, said first and second parts being locked together in a closed position of the pod and unlocked in an open position of the pod.

4. The hydroponic culture pod of claim 1, comprising a first part and a second part, said first and second parts being locked together in a closed position of the pod and unlocked in an open position of the pod; wherein:
the first part comprises first anchoring cones extending along a height of an inner wall thereof between a bottom wall and a top edge thereof;
the second part comprises second anchoring cones along a height of an inner wall thereof and extending from an inner wall thereof between a bottom wall and a top edge thereof.

5. The hydroponic culture pod of claim 1, comprising a first part and a second part, said first and second parts being locked together in a closed position of the pod and unlocked in an open position of the pod; wherein:
the first part comprises first anchoring cones extending along a height of an inner wall thereof between a bottom wall and a top edge thereof;
the second part comprises second anchoring cones along a height of an inner wall thereof and extending from an inner wall thereof between a bottom wall and a top edge thereof in a position in the open position of the pod selected for a staggered relative position with the first anchoring cones within the pod in the closed position of the pod.

6. The hydroponic culture pod of claim 1, comprising a first part and a second part, said first and second parts being locked together in a closed position of the pod and unlocked in an open position of the pod;
wherein:
the first part comprises a first insert in an inner wall thereof;
the second part comprises a second insert in a position in an inner wall thereof in the open position of the pod selected for a facing relative position within the pod in the closed position of the pod to support the germination tray in the closed position of the pod.

7. The hydroponic culture pod of claim 1, comprising a first part and a second part, said first and the second parts being locked together in a closed position of the pod and unlocked in an open position of the pod;
wherein:
the first part comprises first aligning pins extending along a height of an inner wall thereof between a bottom wall and a top edge thereof;
the second part comprises second aligning pins extending along a height of an inner wall thereof between a bottom wall and a top edge thereof; and
wherein the first and second aligning pins are positioned on the first and second parts respectively in the open position of the pod selected for a mating engagement within the pod in the closed position of the pod.

8. The hydroponic culture pod of claim 1, comprising a first part and a second part, said first and the second parts being locked together in a closed position of the pod and unlocked in an open position of the pod;
wherein:
the first part comprises first shading blinds extending from an inner wall thereof; and
the second part comprises second shading blinds extending from an inner side wall thereof.

9. The hydroponic culture pod of claim 1, comprising a first part and a second part, said first and the second parts being locked together in a closed position of the pod and unlocked in an open position of the pod;
wherein:
the first part comprises first shading blinds extending from an inner wall thereof;
the second part comprises second shading blinds extending from an inner side wall thereof; and
wherein said shading blinds are flexible elements extending from the inner side walls of the pod between the germination tray and a top of the pod in the closed position of the pod.

10. The hydroponic culture pod of claim 1, comprising a first part and a second part, said first and the second parts being locked together in a closed position of the pod and unlocked in an open position of the pod;
wherein:
the first part comprises, extending from an inner wall along a height between a bottom wall and a top edge thereof: first anchoring cones, first aligning pins and first shading blinds; and a first insert in the inner wall thereof;
the second part comprises, extending from an inner wall along a height between a bottom wall and a top edge thereof: second anchoring cones, second aligning pins and second shading blinds; and a second insert in the inner wall thereof.

11. The hydroponic culture pod of claim 1, wherein said flexible elements are bristles of at least one of: selected lengths, selected diameters, and selected density, on the germination tray.

12. The hydroponic culture pod of claim 1, made in an elastomer.

13. The hydroponic culture pod of claim 1, made in a food grade silicone.

14. The hydroponic culture pod of claim 1, wherein the germination tray comprises a reservoir of solution.

15. A hydroponic culture system, comprising the pod of claim 1, a grow tray, and a reservoir of nutrient solution; wherein the pod is placed in the grow tray, and the grow tray is selectively fed with the nutrient solution from the reservoir depending on targets.

16. A hydroponic growing method, comprising:
providing a pod comprising two parts configured to be locked together in a closed position of the pod and unlocked in an open position of the pod; at least a first one of said two parts comprising first anchoring cones extending along a height of an inner wall thereof between a bottom wall and a top edge thereof;
placing seeds in an array of bristles on a germination tray;
inserting the germination tray into a first part of the pod, and locking the two parts together in the closed position of the pod;
whereby the flexible elements support the plant seeds, and the anchoring cones support and anchor plants growing from the seeds and expanding out a top of the pod.

17. The hydroponic growing method of claim 16, wherein:
the first part comprises first anchoring cones extending along a height of an inner wall between a bottom wall and a top edge thereof;
the second part comprises second anchoring cones extending along a height of an inner wall between a bottom wall and a top edge thereof in a position in the open position of the pod selected for a staggered relative position with the first anchoring cones within the pod in the closed position of the pod.

18. The hydroponic growing method of claim 16, wherein the first part comprises a first insert in an inner wall thereof and the second part comprises a second insert in an inner wall thereof, said first and second inserts being selectively positioned on the first and second parts respectively in the open position of the pod for a facing relative position within the pod in the closed position of the pod to support the germination tray.

19. The hydroponic growing method of claim 16, wherein the first part comprises first aligning pins along a height of an inner wall between a bottom wall and a top edge thereof; and the second part comprises second aligning pins along a height of an inner wall between a bottom wall and a top edge thereof;
and wherein the first and second aligning pins are selectively positioned on the first and second parts respectively in the open position of the pod for mating engagement within the pod in the closed position of the pod.

20. The hydroponic growing method of claim 16, wherein the first part comprises first shading blinds extending from an inner wall thereof; and the second part comprises second shading blinds extending from an inner side wall thereof.
